(19) United States
(12) Patent Application Publication
(10) Pub. No.: US 2018/0282528 A1
(43) Pub. Date: Oct. 4, 2018

(54) STABILIZED STARCH

(71) Applicant: BOARD OF SUPERVISIORS OF LOUISIANA STATE UNIVERSITY AND AGRICULTURAL AND MECHANICAL COLLEGE, Baton Rouge, LA (US)

(72) Inventors: Joan M. KING, Baton Rouge, LA (US); Yu JIANG, Westrninster, CO (US)

(21) Appl. No.: 15/525,370

(22) PCT Filed: Nov. 9, 2015
(86) PCT No.: PCT/US2015/059699

§ 371 Date: May 9, 2017

Related U.S. Application Data
(60) Provisional application No. 62/077,493, filed on Nov. 10, 2014.

(51) Int. Cl. C08L 3/02; C08K 5/09; C08K 5/37

(52) U.S. Cl. CPC C08L 3/02; A23L 29/212; C08K 5/37; C08K 5/09

(57) ABSTRACT

A novel starch product that is surprisingly stable has been discovered and produced by a novel method comprising mixing a free amino acid and an individual fatty acid with native starch. This novel starch product is free of the typical cross-linking chemicals used to stabilize native starch. We have generated a treated rice starch product with low breakdown and low retrogradation tendency, making it more resistant to heat and shearing in process. This novel rice starch also showed good stability under freeze-thaw cycle. The novel starch product showed 60%-100% less viscosity breakdown than the native starch. Other native starches show similar improved stability. Starch products of low breakdown value are widely used in food and pharmaceutical industries.

### FIELD OF THE INVENTION

A method has been discovered to produce a novel stabilized starch product that is resistant to heat, shearing and acid treatment.

The method comprises treatment of starch product with a combination of individual fatty acids and free amino acids.

The resulting starch product exhibits superior characteristics comprising reduced breakdown, low retrogradation, and good stability under freeze-thaw cycles.

### BACKGROUND OF THE INVENTION

The history of humans eating starchy food can be tracked back to the beginning of civilization. Starch from different botanical sources, including seeds, tuber and roots was heated with or without water for basic food needs. Although wheat, corn and rice are three main sources of starch with almost equal amounts of production, different cereals and starches are favored in different regions of the world. Corn is indigenous to the Americas. Asia contributed the biggest percentage of rice and wheat production to the world in the year 2011.

Starch is a naturally occurring polymer comprised of glucose units, amylose and amylopectin, whereas amylose units are essentially linear chains and amylopectin are typically highly branched structures.

Native starch exists in the form of starch granules, which are packed with amorphous amylose and amylopectin in semi-crystalline rings. Most native starch has between about 10-40% amylose, depending on a number of factors including botanical source, growth condition, and harvesting time. For example, amylose content ranges from 20% to 36% for corn starch; from 18% to 23% for potato starch; from 21% to 35% for sorghum starch; from 17% to 29% for wheat starch; from 11% to 26% for rice starch; and from 34% to 37% for pea starch.

Starches from different plant sources exhibit different size, amylose/amylopectin ratio, granule organization and granule surface compounds, which also result in different thermal, pasting and other physicochemical properties.

For use of starch within the food industry, native starches exhibits certain undesirable texture problems during cooking. It is desirable that starch remain stable when undergoing typical processes such as heating, agitation, or acid treatment. For example, while heating causes the viscosity of starch to increase, continuous heating with stirring causes the viscosity to decrease. While not being bound by this explanation, it appears that the viscosity decrease is due to the rupture of starch granule, a process which is called breakdown. When starch undergoes breakdown, the starch becomes cohesive and usually lower in viscosity than desired. Long time storage of starch under low temperature causes starch to recrystallize and loose its softness, a process which is called retrogradation.

At room temperature, native starch is insoluble in cold water. Upon heating, as water begins to penetrate the starch granules the starch begins to swell, referred to as gelatinization. Continuous heating destroys the crystalline regions of starch granule and causes significant swelling which is a stage called pasting where the starch reaches peak viscosity. At this point, molecular order in starch granules changes accompanied by irreversible starch swelling, leaching of amylose, and granule collapse. Granule collapse results in decreased viscosity of the starch.

After gelatinization occurs, additional heating may cause significant disruption of starch granules causing the starch viscosity to decrease until it reaches minimum viscosity. The difference between peak viscosity and minimum viscosity is called breakdown. This characteristic of starch defines stability of starch during cooking, or vulnerability of starch to being disrupted by other factors, such as shearing or acidic conditions, which also can accelerate starch granule collapse and breakdown.

Cooling starch product after gelatinization and pasting occurs causes an increase its viscosity, due to what is believed to be the association of starch gel. This process is called starch retrogradation. For example, starch retrogradation appears to be the main reason for bread staling or undesirable firming of other starchy food. Native starch with a high retrogradation rate would not be suitable in frozen food. High retrogradation may be a desirable attribute for products that require crispy structure and low stickiness, such as breakfast cereal.

It is desirable to be able to stabilize starch product to control breakdown and retrogradation.

### PRIOR ART

Conventionally, to restrain swelling or gelatinization, food starches have been modified by crosslinking the starch with a variety of chemicals, for example, phosphoryl chloride, sodium trimetaphosphate (STMP), orthophosphate, adipic acid or acetic acid.

Typically, starch is mixed with a crosslinking agent in a neutral or basic aqueous solution, dried, and then heated. Acid is used to terminate the reaction.

In U.S. Pat. No. 2,884,413, cross-linked starch was prepared by phosphorylation of starch using a variety of inorganic phosphates including sodium metaphosphate, polyphosphate, hexametaphosphate, and pyrophosphate. The reaction mixture has to be heated to 100-160° C. for cross-linking of the starch molecules.

In U.S. Pat. No. 4,098,997, an acetal cross-linked starch was prepared by reacting a granular starch with a propiolate ester at pH 6.5-12.5 at a temperature of 5° C. to 60° C. for 0.2-24 hr, of which linkage can be readily removed under acidic conditions.

In European Patent EP 0796868 B1, a high viscosity waxy potato starch was obtained by using typical crosslinking agents.

In PCT Patent Application Publication WO 2006/133335 A2, a reversibly swellable granular starch-lipid was disclosed that included typical crosslinking agents, such as phosphorylating agents or epichlophydrin, to interact with the lipid.

Large amounts of water are often needed to wash away the chemical residues or other impurities resulting from typical starch stabilization using chemicals. It is common that some chemicals used for treatment remain in the treated starch after washing.

The food industry prefers not to use chemicals to stabilize starch in edible foods because of the residual chemicals that becomes part of the starch, and because often residual chemicals remain.

Starch also has been stabilized by combining a starch with other natural products.

European Patent EP 0030448 B1 discloses a method for fortifying foods with a sulfur-containing free amino acid dispersed in a liquid or softened plastic fat or oil.

PCT Patent Application Publication WO 2003/102072 A1 discloses a method to stabilize starch against decomposition by combining a lipid, such as an individual fatty acid, with starch.

Native or added proteins when added to starch are known to change starch properties.

The effects of free amino acids addition to starch functional properties are known to have limited effects on starch. (Xiaoming Liang (2001); “Effects of Lipids, Amino Acids, and Beta-Cyclodextrin on Gelatinization, Pasting, and Retrogradation Properties of Rice Starch;” Unpublished Doctoral Dissertation; Louisiana State University; Baton Rouge, La., USA); (Xiaoming Liang and Joan M. King; “Pasting and Crystalline Property Differences of Commercial and Isolated Rice Starch With Added Amino Acids;” Journal of Food Science; 2003; Pages 832-838; Volume 68, Number 3; Institute of Food Technologies (IFT); Chicago, Ill., USA); (S. Lockwood, J. M. King and D. R. Labonte; “Altering Pasting Characteristics of Sweet Potato Starches Through Amino Acid Additives;” Journal of Food Science; 2008; Pages 373-377; Volume 73; Number 5, Institute of Food Technologies (IFT); Chicago, Ill., USA), and (Azusa Ito, Makoto Hattori, Tadashi Yoshida, Keiji Yoshimura and Koji Takahashi; “Contribution of Charged Amino Acids to Improving the Degraded Viscosity of Potato Starch Paste by a Retort Treatment and During Storage;” Journal of Applied Glycoscience; 2011; Pages 79-83; Volume 58; Number 3; Japanese Society of Applied Glycoscience; Tokyo, Japan).

Addition of charged free amino acids, such as lysine and monosodium glutamate, to starch resulted in inhibited peak viscosity and collapse of potato starch granules at pH 7 under retort treatment. (Azusa Ito, Makoto Hattori, Tadashi Yoshida and Koji Takahashi; “Contribution of the Net Charge to the Regulatory Effects of Amino Acids and ε-Poly(_{L}-lysine) on the Gelatinization Behavior of Potato Starch Granules;” Bioscience, Biotechnology, and Biochemistry; 2006; Pages 76-85; Volume 70; Number 1; Japan Society for Bioscience, Biotechnology and Agrochemistry; Tokyo, Japan).

While lysine was found to depress starch breakdown for orange-fleshed sweet potato starch and white-fleshed sweet potato starch, it caused a higher breakdown value in rice starch as compared to starch with no additive. (Rosaly V. Manalis (2009); “Modification of Rice Starch Properties By Addition of Amino Acids at Various pH Levels;” Published Master Thesis; Louisiana State University; Baton Rouge, La., USA).

Different roles of aspartic acid and lysine additives were found in sweet potato in changing pasting stability. (S. Lockwood, J. M. King and D. R. Labonte; “Altering Pasting Characteristics of Sweet Potato Starches Through Amino Acid Additives;” Journal of Food Science; 2008; Pages 373-377; Volume 73; Number 5, Institute of Food Technologies (IFT); Chicago, Ill., USA).

Lipids, such as free fatty acids, mono-, di- and tri-glycerides, have been used in food applications for different purposes. A main function of lipid, for example, monoglyceride and sodium stearoyl lactylate, in starchy food is to retard firming and staling, which is related to inhibited starch retrogradation.

However, no one has combined starch, free amino acids and individual fatty acids. Surprisingly, we discovered that unexpectedly high stability was afforded to starch by combining starch with free amino acids and individual fatty acids, in excess of the expected additive effect of these additions.

### BRIEF SUMMARY OF INVENTION

In this invention, native starches were mixed with individual fatty acids and free amino acids.

The native starches comprise rice starch, potato starch, corn starch, wheat starch, tapioca starch, oat starch, barley starch, and waxy maize starch.

The free amino acids comprise lysine, glycine, glutamine, aspartic acid, leucine, tyrosine, and cysteine.

The individual fatty acids comprise stearic acid, palmitic acid, linoleic acid, linolenic, and oleic acid.

The resulting novel starches exhibited increased pasting temperature decreased breakdown values and less retrogradation, when compared to native starch.

### BRIEF DESCRIPTION OF DRAWINGS

FIG. 1 is a Differential Interference Contrast Microscope photograph of stained RVA heat treated samples without additional heating.

FIG. 2 is a Differential Interference Contrast Microscope photograph of stained RVA heat treated samples which have undergone additional heating.

FIG. 3 is RVA curves of rice starch untreated and treated with stearic acid and amino acids.

### DETAILED DESCRIPTION OF INVENTION

In this invention, starch product with low breakdown and good stability at refrigeration temperature was created by adding a combination of an individual fatty acid, for example, stearic acid, and a free amino acid, for example, glycine, lysine, glutamine or cysteine to granular native starch.

The pH of a mixture comprising an individual fatty acid, a free amino acid and starch was adjusted to a value between 8-11, preferably to pH 10, using sodium hydroxide if necessary. The mixture was then slurried.

For treated rice starch, the individual fatty acid concentration was maintained between about 0.1% and 1.5%, with a preferred range between about 0.2% to 1.0% percent. The concentration of the free amino acids was maintained between about 1%-6%, with a preferred range between 2%-4%. Both individual fatty acid and free amino acid concentrations were on a starch dry weight basis.

The individual fatty acids comprise stearic acid, palmitic acid, linoleic acid, linolenic, and oleic acid.

The free amino acids comprise lysine, glycine, glutamine, aspartic acid, leucine, tyrosine, and cysteine.

Rapid visco analyzer (“RVA”) was used to mimic heating and shearing condition, which includes a controlled heat-hold-cool temperature cycle. Each sample was held in an aluminum canister at 50° C. for 10 sec, with a stirring speed of about 960 rpm. The stirring speed was then reduced to about 160 rpm as the temperature of the mixture was increased at a rate of 12° C./min until the temperature of the mixture reached approximately 95° C. The mixture was maintained at about 95° C. for about 2.5 min. Then, the canister was cooled to 50° C. at a rate of −12° C./min. During the entire heating and cooling process, the stirring speed was kept at 160 rpm.

The novel starch mixtures were then dried by freeze-drier in accordance with conventional procedures and then milled into powders for storage.

### Example 1: Method for Producing Rice Starch Product of Low Breakdown by Adding Fixed Amount of Stearic Acid and Variable Amounts of Lysine

Rice starch was purchased from Sigma Chemical Co. (S7260). By proximate analysis, this batch of rice starch had 11.7% moisture, 0.20% lipid, 0.70% protein. There was 24.9% amylose based on dry rice starch weight.

To prepare a starch product with low breakdown, 2.91 g the rice starch was mixed with 0.4% stearic acid (on a starch dry weight basis) and to that was added lysine ranging in concentration from 2%-6% (on a starch dry weight basis). About 25 g distilled water was added to the starch additive mixture in order to reach a final starch slurry of approximately 28 g. The slurry had a pH of about 10. Pasting characteristics of the starch slurries were tested by RVA analysis, wherein the Peak Viscosity (Peak), minimum viscosity (MV), final viscosity (FV), pasting time (Ptime) and pasting temperature (Ptemp) were measured. Further, breakdown (BKD) and total setback (TSK) were calculated, and all viscosity data reported in centipoise (cP).

Rice starch that was treated by adding both stearic acid and lysine showed increased pasting temperature, from 83 to 91° C., and postponed peak time from 6.87 min to 7.96 min when compared to the control, untreated rice starch (See Table 1).

It appears that treatment of native rice starch caused starch to resist swelling and pasting. The breakdown value for the treated starch dropped from 241 cP for commercial starch to 71 cP for starch with 0.4% stearic acid and 6% lysine added. These changes in the starch characteristics when treated with stearic acid and lysine would appear to enhance cooking stability of rice starch. See Table 1 below for results for varying concentrations of stearic acid and lysine.

TABLE 1
Effects Of 0.4% Stearic Acid And 2%, 4% And 6% Lysine At
Different Concentration On Pasting Properties Of Commercial Rice

| Stearic | | | | | | | | |
|---|---|---|---|---|---|---|---|---|
| Acid | Lysine | Peak | | BKD | | Ptime | Ptemp | TSB |
| (%) | (%) | (cP) | MV (cP) | (cP) | FV (cP) | (min) | (° C.) | (cP) |
| 0 | 0 | 2372.33b | 2131.67b | 240.67a | 3112.00b | 6.87c | 83.15c | 980.33a |
| 0.4 | 2 | 2517.33a | 2424.33a | 93.00b | 3425.67a | 7.58b | 88.92b | 1001.33a |
| 0.4 | 4 | 2507.67a | 2431.00a | 76.67bc | 3458.67a | 7.82ab | 89.22ab | 1027.67a |
| 0.4 | 6 | 2506.33a | 2435.33a | 71.00c | 3331.67a | 7.96a | 91.28a | 896.33a |

FA—fatty acid;
MV—minimum viscosity;
BKD—breakdown;
FV—final viscosity;
Ptemp—pasting temperature;
Ptime—peak time;
TSB—total setback.
The levels are based on starch dry weight.
Values followed by the same letter in the same column are not significantly different (P > 0.05).

### Example 2: Starch with Fixed Amount of Lysine and Varying Amounts of Stearic Acid Added Showed Highly Restricted Swelling and Pasting Properties

The concentrations of stearic acid of 0.4%, 0.6%, 0.8, and 1.0% were added to rice starch, along with lysine at 6%. The preparation for starch mixture was the same as described above in Example 1. The starch slurry was at approximately pH 10. Pasting characteristics of the above starch slurries, including starch control, starch with added 0.4% stearic acid and 6% lysine, starch with added 0.6% stearic acid and 6% lysine, starch with added 0.8% stearic acid and 6% lysine, and starch with added 1.0% stearic acid and 6% lysine were tested by RVA analysis. The results are shown in Table 2.

TABLE 2
Effects Of 0.4%, 0.6%, 0.8% And 1.0% Stearic Acid And 6% Lysine
Combination On Pasting Properties Of Commercial Rice

| Stearic | | | | | | | | |
|---|---|---|---|---|---|---|---|---|
| Acid | Lysine | | | BKD | | Ptime | Ptemp | TSB |
| (%) | (%) | Peak (cP) | MV (cP) | (cP) | FV (cP) | (min) | (° C.) | (cP) |
| 0.4 | 6 | 2506.33a | 2435.33a | 71.00a | 3331.67a | 7.96a | 91.25c | 896.33a |
| 0.6 | 6 | 2198.67b | 2119.00b | 79.67a | 2555.33b | 8.09a | 94.58b | 436.33b |
| 0.8 | 6 | 1685.67c | 1648.00c | 37.67b | 1743.33c | 8.00a | 94.85b | 95.33c |
| 1.0 | 6 | 1231.67d | n/a* | n/a* | 1101.33d | 7.82a | 95.08a | n/a* |

n/a*—indicated the value did not exist because of changed shape of RVA curve.
MV—minimum viscosity;
BKD—breakdown;
FV—final viscosity;
Ptemp—pasting temperature;
Ptime—peak time;
TSB—total setback.
The levels are based on starch dry weight.
Values followed by the same letter in the same column are not significantly different (P > 0.05).

As shown in Table 2, when lysine was kept at 6%, addition of higher concentrations of stearic acid, 0.4%, 0.6%, 0.8% and 1.0%, produced a starch slurry with average peak viscosities (“Peak”) of 2506.33 cP, 2198.67 cP, 1685.67 cP and 1231.67 cP, respectively.

Peak time values (“Ptime”) for each treated starch slurry were significantly delayed when compared to control. The treated starch slurries showed that as the amount of stearic acid increased, the viscosity of the slurry (“Peak”, “MV”, and “FV”) decreased. Lower viscosities typically indicate a high degree of cross-linking, while higher viscosities typically indicate a low cross-linking degree. The degree to which starch swelling (“Peak”) is restricted, appears to be proportional with concentration of stearic acid for the concentrations examined. Total setback (“TSK”), which indicates potential for retrogradation of the starch, decreased with increased stearic acid added in the presence of 6% lysine.

Mixing of starch with a combination of free amino acids and individual fatty acids convert the starch into a starch that resembles a chemically treated cross-linked starch.

### Example 3: Microscopic Observation for Rice Starch Product with Stearic Acid and Lysine as Additives

A microscopic comparison was made between rice starch (control), rice starch with 6% lysine added, rice starch with 1% stearic acid added, and rice starch with 6% lysine and 1% stearic added.

The slurries were prepared by RVA heat treatment as described in Example 1. The dried starch products were milled and screened with a 0.5 mm screen in a Cyclone Sample Mill (Udy Corp., Port Collins, Colo.).

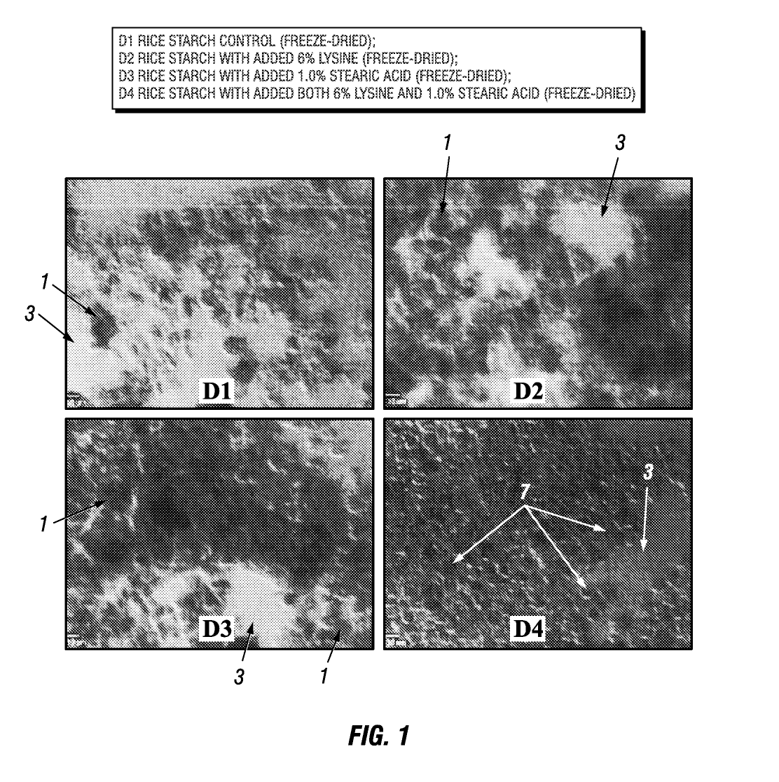

Mixtures of 3% starch slurries were prepared from each of the four freeze-dried rice samples described above, and each mixture was stirred for approximately 2 hrs. Each mixture was divided with one half of each starch mixture re-heated at 90° C. for 20 min to check their heating stability; the other half was not heated. All starch mixtures, four mixtures both heated and un-heated, were stained using 2% I₂-KI solution (0.2 g I₂ and 2 g KI in 100 ml distilled water). The starch mixtures that had not been re-heated were designated D1, D2, D3 and D4 respectively. The starch mixtures that were re-heated were designated H1, H2, H3 and H4 respectively. The stained samples were photographed using differential interference contrast microscopy (Leica DM RXA2). The results for the before-heating examples are shown in FIG. 1.

FIG. 1 showed that starches with additives exhibited different degrees of rupture after preparation by RVA heat treatment. In rice starch control (D1) swollen starch fragments (1) can be observed, indicating rupture of starch granules and development of starch gels (3). These starch fragments (1) became even cloudier in rice starch with added 6.0% lysine (D2), suggesting, though this explanation is not required for this invention, that there was an increase in the amount of amylose leached (3) from the starch granules. This explanation was consistent with the result of escalated breakdown of starch with lysine added during the RVA heat treatment caused by rapid starch granule rupture.

In rice starch treated with 1.0% stearic acid (D3), starch granules (1) showed shape with more clarity than starch with added 6.0% lysine (D2). It would appear that the addition of stearic acid caused less starch granule rupture.

In rice starch treated with 1.0% stearic acid and 6.0% lysine (D4), far more intact swollen starch granules (7) were observed. This serves as strong evidence that addition of both 1.0% stearic acid and 6.0% lysine inhibited starch pasting by keeping swollen starch granules structure from rupturing.

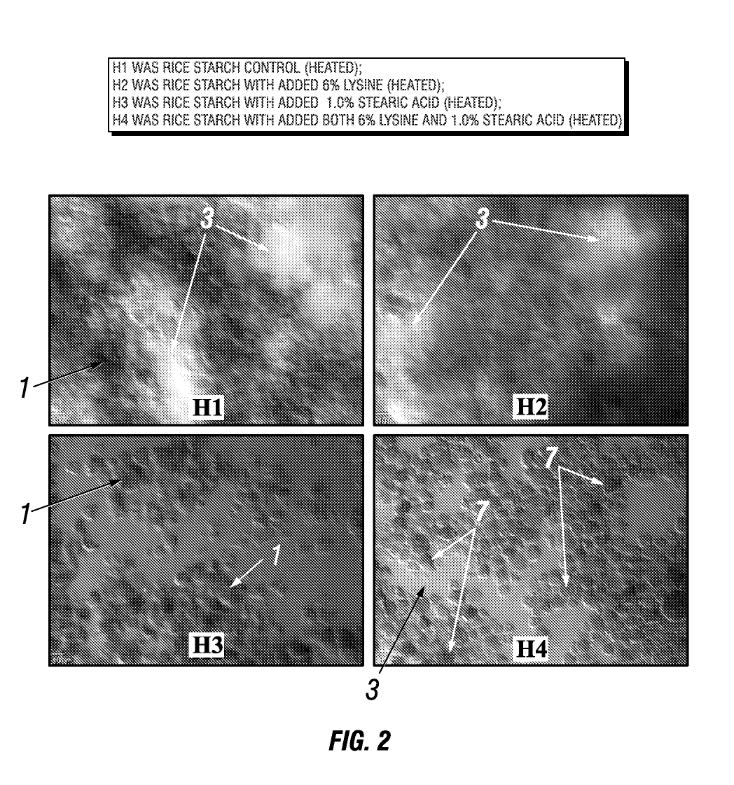

FIG. 2 displays the microphotographs of the rice starch and rice starch with additives after heating.

Rice starch heated (H1) and rice starch heated with either lysine or stearic acid (H2 and H3, respectively) displayed increased amylose leaching, giving more blurred and fuzzier starch granule shape than unheated samples. The starch in H1 shows significant amounts of starch gel (3). Addition of the lysine (H2) shows few starch granules and with more starch gel (3). The addition of stearic acid (H3) appears to result in more distinct swollen granules (1) as well as starch gel (3). Surprisingly, the shape of rice starch granule with both stearic acid 1.0% and lysine 6.0% (H4) added remained intact (7). Since neither starch treated with either a free amino acid nor an individual fatty acid alone produced stable starch granules, it was surprising that the combination of a free amino acid and an individual fatty acid would have such a dramatic effect.

The novel starch comprising native starch, a free amino acid, and an individual fatty acid appears to be heat-resistant and resistant to swelling and pasting. While not requiring this explanation for the invention, it appears that the reduced peak viscosity found in native starch treated with 1.0% stearic acid and 6.0% lysine, was caused by inhibited starch swelling, rather than starch hydrolysis.

### Example 4: Starch with Highly Restricted Swelling and Pasting Properties by Stearic Acid and Other Free Amino Acids Addition

Rice starch was mixed with 1% stearic acid and 6% glycine, glutamine, or cysteine (starch dry weight basis). The sample preparation was the same procedure as described in Example 1 above. The pH of the starch slurry was adjusted to 10 by sodium hydroxide. Pasting characteristics of the above starch samples were tested by RVA analysis as Example 1.

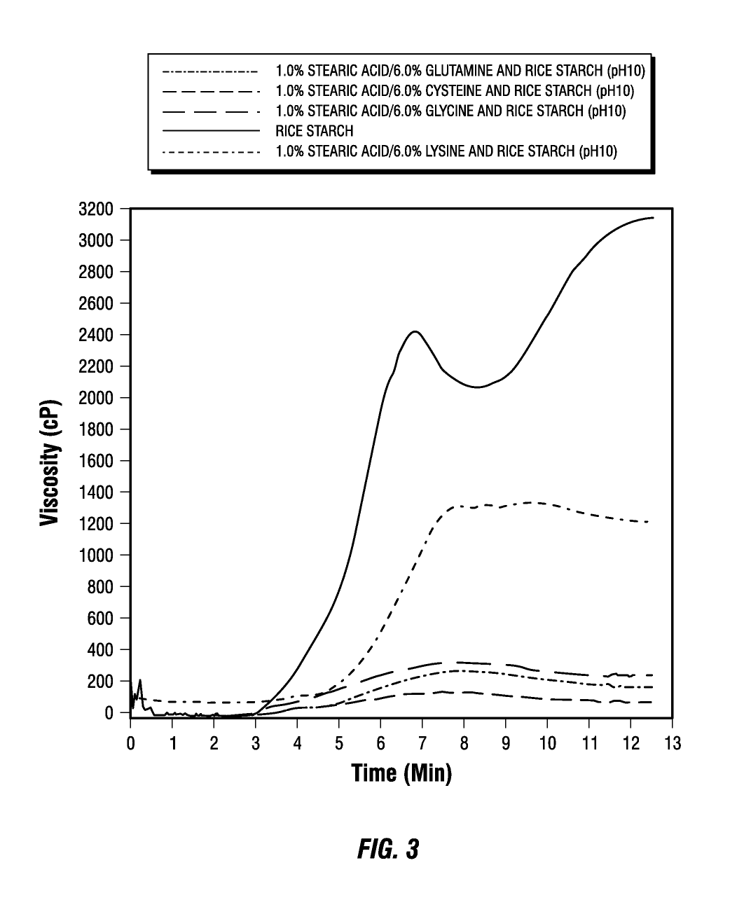

Similar to lysine, addition of both 6.0% glycine and 1.0% stearic acid at pH 10 showed inhibited starch pasting. The trough of its RVA curve disappeared and its highest viscosity was only 10.6% of the peak viscosity of starch control. The time to reach peak viscosity was postponed 1.5 min, compared to starch control. Cysteine and glutamine addition both demonstrated similar inhibited starch pasting as glycine. The degrees of inhibited swelling for cysteine and glutamine were even higher than that of lysine. Because of their unique pasting curves, peak viscosity, minimum viscosity, and breakdown values could not be obtained. Results are shown in FIG. 3, where viscosity is plotted against time for rice starch untreated and treated with 1.0% stearic acid and 6.0% amino acids. The amino acids included glutamine, cysteine, glycine and lysine.

### Example 5: Treated Starch Leads to Reduction in Retrogradation

The samples were prepared as described in Example 3. The samples including (1) rice starch control, (2) rice starch with 6% lysine added, (3) rice starch with 1.0% stearic acid added, and (4) rice starch with both 1.0% stearic acid and 6% lysine added. Individual fatty acids and free amino acids were added on a starch dry weight basis. All samples were examined using RVA heating cycles as described in Example 1 above. The starch products were freeze-dried and then milled with a 0.5 mm screen in the Cyclone Sample Mill (Udy Corp., Port Collins. Colo.).

Twenty mg of distilled water was added to 10 mg of each of these starch samples in pans. The samples were then sealed and stored at room temperature overnight for starch hydration. The pans were heated in a differential scanning calorimeter (DSC) beginning at 15° C. and then increasing the temperature to 140° C. at a rate of S ° C./min. After the above DSC tests, pans were cooled to room temperature, and then refrigerated at 4±1° C. for 10 days. The starch samples were removed from the refrigerator and allowed to remain at room temperature for 2 hrs. Another pan containing 20 ml distilled water was used as a reference. The thermal transition parameters, including enthalpy (Jig), onset temperature and peak temperature were determined.

The degree of starch retrogradation was calculated as follows:

% retrogradation=100*[ΔH1/ΔH2]

where ΔH1 is the enthalpy change of the thermal transition for retrograded starch and ΔH2 is the enthalpy change for the thermal transition of starch gelatinization.

TABLE 3
Retrogradation Of Selected RVA Treated Samples After 10 Days
Refrigeration Storage

| Sample (RVA heated) | Starch-Lipid Complex Form | | | | Retrogradation Peak | | |
|---|---|---|---|---|---|---|---|
| (%) | To(° C.) | Tp(° C.) | ΔH (J/g) | To (° C.) | Tp (° C.) | ΔH (J/g) | Percentage |
| Control Rice Starch | n/a | n/a | n/a | 43.84 | 53.34 | 4.99 | 41.38 |
| Lysine 6% Added | n/a | n/a | n/a | 40.08 | 51.43 | 5.28 | 43.78 |
| Stearic 1.0% Added | 102.38 | 104.10 | 2.16 | 40.56 | 51.10 | 4.56 | 37.81 |
| Stearic 1.0%/Lysine 6% | 100.46 | 110.13 | 2.08 | 45.24 | 53.75 | 1.60 | 13.27 |
| Added | | | | | | | |

Control Starch Is Starch Without Any Additive

Retrogradation peak was found in samples after being stored for 10 days under refrigeration. It is widely accepted that starch retrogradation under long time storage is caused by amylopectin crystallization, which can be measured by DSC in a temperature range of 40-100° C. The peak temperature for the starch samples ranged from 51.1° C. to 58.8° C.

The gelatinization temperature of raw rice starch is about 20° higher than the values obtained from the DSC, indicating a less ordered and less perfect starch structure for the treated starches than found for native starch granules.

The addition of lysine and stearic acid to native starch caused the retrogradation enthalpy to be lower than the retrogradation peak for the control starch.

Starch treated only with lysine was not as effective in lowering the retrogradation enthalpy.

Starch treated only with stearic acid was not as effective in lowering the retrogradation enthalpy.

1. A starch product comprising native raw starch, an individual fatty acid and an free amino acid, wherein the starch product exhibits pasting properties similar to chemically cross-linked starch, and wherein no typical crosslinking agents, such as, but not limited to, phosphorylating agents or epichlophydrin, are used.

2. A process according to claim 1, wherein the starch is selected from corn starch or rice starch.

3. An individual fatty acid according to claim 1 wherein the individual fatty acids is selected from the group consisting of stearic acid, palmitic acid, linoleic acid, linolenic, and oleic acid.

4. An individual fatty acid according to claim 3 wherein the individual fatty acid is stearic acid or oleic acid.

5. An individual fatty acid according to claim 4 wherein the individual fatty acid is stearic acid.

6. A free amino acid according to claim 1 wherein the free amino acid is selected from the group consisting of glycine, lysine, tyrosine, aspartic acid, glutamine, and cysteine.

7. A free amino acid according to claim 6 wherein the free amino acid is cysteine.

8. A starch product according to claim 1 wherein the starch product comprises between 0.2% and 6% free amino acids, between 0.1% and 1.0% individual fatty acid, both on a starch weight basis, and the remainder native starch.

9. A starch product according to claim 8 wherein the starch product comprises 6% lysine and 1% stearic acid, both on a starch weight basis, and the remainder native starch.

10. A process to produce a stable starch product that is resistant to degradation from continuous heating and shearing by mixing a native starch with individual fatty acids and free amino acids wherein the pH of the mixture is greater than 7.0, and heated to a temperature between 80° C. and 120° C.

11. A process according to claim 10 to produce a stable starch product that is resistant to degradation from continuous heating and shearing by mixing a native starch with individual fatty acids and free amino acids monomers wherein the pH of the mixture is between 9.0 and 10.5, and heated to a temperature between 90° C. and 100° C.

12. A process according to claim 10, wherein the starch is selected from the group consisting of rice starch, corn starch, wheat starch, barley starch and oat starch.

13. A process according to claim 12, wherein the starch is selected from corn starch or rice starch.

14. A process according to claim 13, wherein the starch is rice starch.

15. A process according claim 10, wherein the starch is treated with combination of individual fatty acids and free amino acids monomers or wherein the individual fatty acids are selected from the group consisting of stearic acid, palmitic acid, linoleic acid, linolenic, and oleic acid; wherein the free amino acids are selected from the group consisting of lysine, glycine, glutamine, aspartic acid, leucine, tyrosine, and cysteine.

16. A process according to claim 10, wherein no pre-treatment of native starch is required before addition of individual fatty acids and free amino acid monomers.

17. A process according to claim 15, wherein individual fatty acids are 0.2%-1.0% of the mixture free amino acids are 1.0%-6.0% that of starch dry weight, and the remainder of the mixture is native starch.

18. A process according to claim 10 wherein the starch product exhibits a reduced degree of retrogradation and breakdown.
